(19) United States
(12) Patent Application Publication
(10) Pub. No.: US 2014/0055628 A1
(43) Pub. Date: Feb. 27, 2014

(54) INFORMATION PROCESSING APPARATUS, INFORMATION PROCESSING METHOD AND RECORDING MEDIUM

(71) Applicant: CANON KABUSHIKI KAISHA, Tokyo (JP)

(72) Inventor: Keiichiro Yuasa, Tokyo (JP)

(73) Assignee: CANON KABUSHIKI KAISHA, Tokyo (JP)

(21) Appl. No.: 13/970,953

(22) Filed: Aug. 20, 2013

(30) Foreign Application Priority Data
Aug. 27, 2012 (JP) 2012-186698

(51) Int. Cl. G06F 3/00

(52) U.S. Cl. CPC G06F 3/005
USPC 348/207.1

(57) ABSTRACT

Conventionally, when an image is downloaded from an image browsing service, only the image can be downloaded, and a comment and the like in a service screen cannot be referenced at a downloaded location. Provided is an information processing apparatus that acquires and processes an image file provided from the image browsing service on the Internet and user communication information related to the image file, wherein the image file and user communication information including at least one piece of text information based on user setting registered in the image browsing service are acquired from the image browsing service, the acquired at least one piece of text information is converted to image information, at least the converted image information is synthesized to generate a user communication image based on the user setting, and the generated user communication image is output along with the acquired image file.

### BACKGROUND OF THE INVENTION

1. Field of the Invention

The present invention relates to an information processing apparatus, an information processing method and a recording medium for processing an image in an online service and information related to attributes of the image.

2. Description of the Related Art

Due to the popularization of the Internet and digital cameras, it is common to widely disclose photographs taken by individuals on the Internet and to obtain comments of a large number of visitors. The photographers and viewers disclose photographs of the faces of the individuals, virtual characters called avatars, and profile information such as careers and principles, and write comments to the photographs of each other to enjoy virtual communication beyond distance and time on Internet services. Japanese Patent Application Laid-Open No. 2008-148071 proposes an advanced example, in which real-time communication is enjoyed by displaying comments of viewers in real time on a replay screen that is replaying a video stream. To refer to the services on the network, a user generally has to use Internet browser software to connect to a communication network. Although the Internet browser software has a function of saving the referenced screen, dynamic network service data represented by such a stream replay video is statically saved by a saving function of a browser, and the data cannot be referenced after the termination of the connection.

Meanwhile, digital cameras for taking photographs to be disclosed on the Internet include enhanced functions for displaying the taken images, such as a large liquid crystal screen and user-friendly operation through touch panel operation. Therefore, if the data displayed on the screen of the communication service of the image file browsing service on the Internet can be browsed by the camera, that would be more convenient for the user of the digital camera.

Meanwhile, a multi picture format (CIPA DC-007-2009) as a standard issued by Camera & Imaging Products Association proposes a format of recording a plurality of images in one image file. A function of replaying the image file by a digital camera can be advanced in the future.

A technique of converting data that is not an image file, such as photographs, to display the data on a display of a camera is proposed in Japanese Patent Application Laid-Open No. 2002-366561. The proposal illustrates a system that can convert data of each slide page of presentation software to an image file to display the data on a display of a projector or a digital camera.

### SUMMARY OF THE INVENTION

An aspect of the present invention is to solve all or at least one of the problems.

An aspect of the present invention provides an information processing apparatus that acquires and processes an image file provided from an image browsing service on the Internet and user communication information related to the image file, the information processing apparatus including: an image file acquisition unit that acquires the image file from the image browsing service; an information acquisition unit that acquires, from the image browsing service, user communication information including at least one piece of text information based on user setting registered in the image browsing service; a generation unit that converts the acquired at least one piece of text information to image information and that synthesizes the information based on the user setting and the converted image information to generate a communication image; and an output unit that outputs the generated user communication image along with the acquired image file.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a diagram illustrating a configuration of an entire network service including a server that provides an image browsing service and including user terminals according to an embodiment.

FIG. 2 is a diagram illustrating a configuration of the server that provides the image browsing service according to the embodiment.

FIG. 3 is a block diagram of the server that provides the image browsing service according to the embodiment.

FIG. 4 is a diagram illustrating a service screen provided by the image browsing service to a user according to the embodiment.

FIG. 5 is a diagram illustrating a flow chart of operation of the server according to a first example.

FIGS. 6A and 6B are conceptual diagrams of display modes of an image file generated by operation of a server computer according to the first example and a modified example of the first example.

FIG. 7 is a diagram illustrating a screen for setting a layout of the image file by the user who receives the image browsing service according to the embodiment.

FIGS. 8A and 8B are diagrams illustrating layouts of a comment image file according to the first example.

FIG. 9 is a diagram illustrating a flow chart of operation of the server according to a first modified example.

FIG. 10 is a diagram illustrating a flow chart of operation of the server according to a second modified example.

FIG. 11 is a diagram illustrating a flow chart of operation of the server according to a third modified example.

### DESCRIPTION OF THE EMBODIMENTS

Preferred embodiments of the present invention will now be described in detail in accordance with the accompanying drawings.

Various exemplary embodiments, features, and aspects of the invention will be described in detail below with reference to the drawings.

Hereinafter, exemplary embodiments of the present invention will be described in detail with reference to the attached drawings. The embodiments illustrate examples of applying the present invention to servers that operate in a network service for providing an image browsing service.

### Example 1

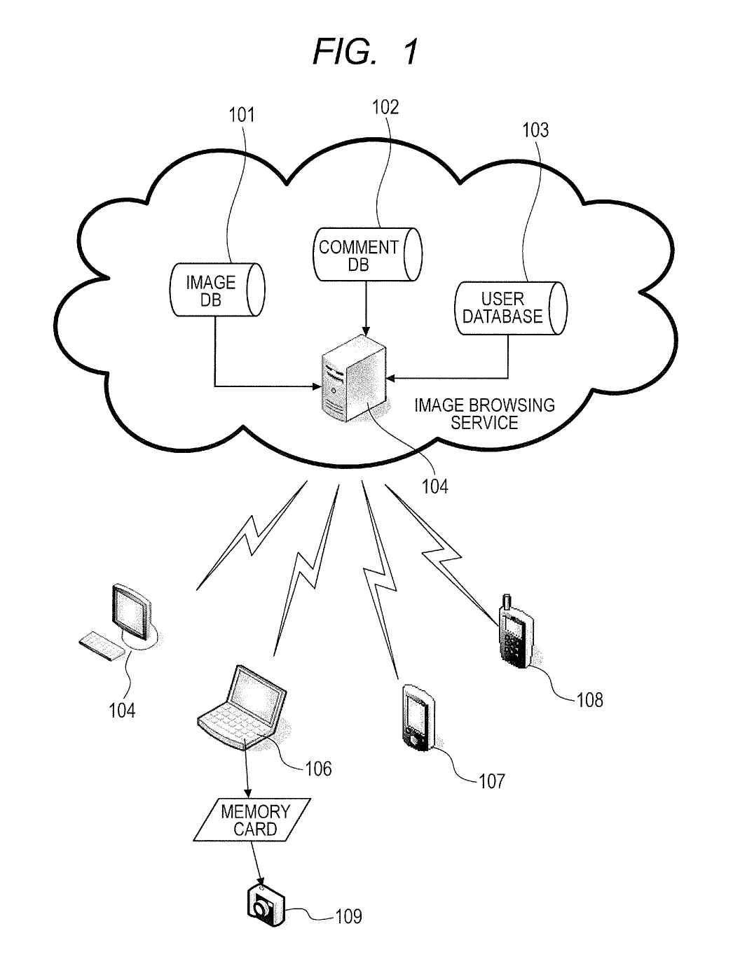

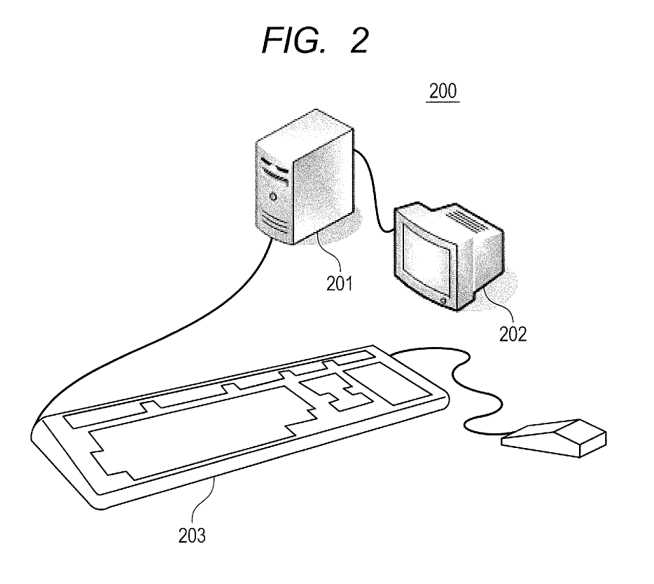

FIG. 1 illustrates an overall configuration of a network service including a server that provides the image browsing service and including user terminals according to an embodiment of the present invention. A network server logically includes a server 104 provided with service logic, and the image browsing service is performed on the Internet in response to requests from the terminals according to the present invention. In that case, photographic image files are stored in an image DB 101, information related to users using the service is stored in a user DB 103, and information of communication performed by the users using the service is stored in a comment DB 102. Although the functions are physically realized in the present example by a computer system illustrated in FIG. 2, distributed servers may be arranged on a network in so-called cloud computing to carry out the functions. The server 104 provides services to various user terminals, such as a Mac 105, a PC terminal 106, a mobile phone 108 and a PDA 107, through various networks, such as radio, wires, WAN and telephone lines. The network services are standard WWW services based on general HTML, and the user terminals can be any user terminals in which browser functions incorporated into the devices or users' desired browser software can understand standard Web protocols. In the present example, a digital camera (109) without a network function may be able to receive service data from the PC terminal 106 through a memory card. The PC terminal 106 includes an output unit that outputs data to be stored in the memory card.

FIG. 2 is a perspective view illustrating an appearance of an example of configuration of a computer system that forms a server providing an image browsing service (set of service logic and service data) according to an embodiment of the present invention. As illustrated in FIG. 2, a computer system 200 that carries out a service process of the present embodiment includes a personal computer 201 connected to an input device 203, such as a keyboard and a pointing device (hereinafter, called “mouse”), and connected to a display 202, such as a CRT. Service data, a server program for executing service logic and a control program (OS) for controlling the computer system are stored in an HDD or the like of the computer system 200. When the computer system 200 executes various programs, a UI screen is displayed on the display 202, and an operation instruction by a server administrator is received from the input device 203.

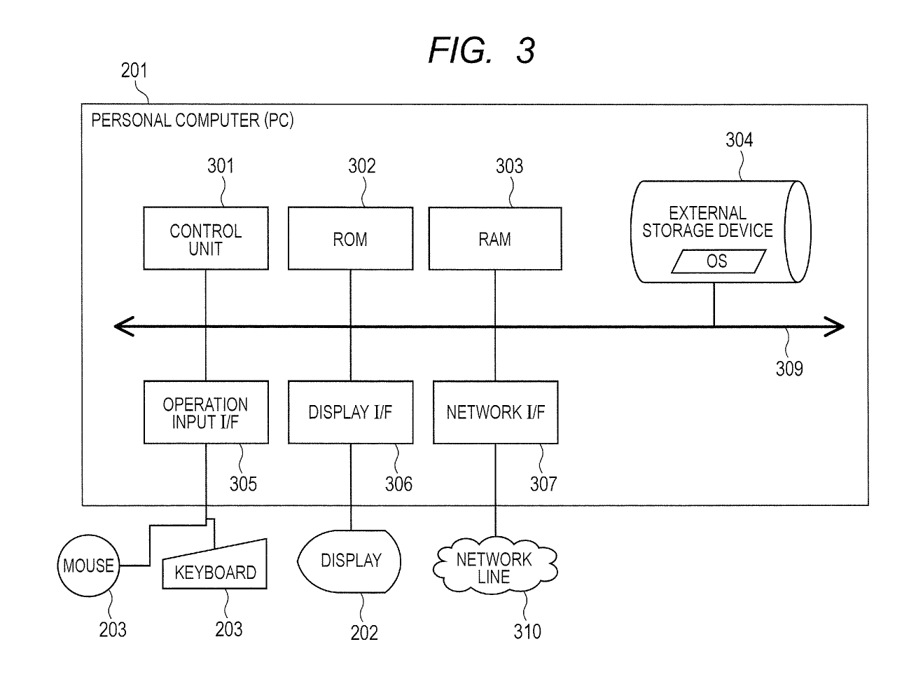

FIG. 3 is a block diagram of the computer system 200. In FIG. 3, the same parts as in FIG. 2 are designated with the same reference numerals.

In FIG. 3, a control unit 301 manages control of the entire computer system 200. A ROM 302 stores programs and parameters that do not have to be changed. A RAM 303 temporarily stores programs and data supplied from external apparatuses. An external storage device 304 is generally an HDD and is used as the databases (DB) 101 to 103 illustrated in FIG. 1. An operation input I/F 305 is an interface of the input device 203 such as a mouse and a keyboard. A display I/F 306 is an interface of the display 202. A network I/F 307 is a network interface for connection with a network 310 such as the Internet, and the network I/F 307 receives a service request from a user terminal connected to the service through the network. A system bus 309 is a bus connecting the components 301 to 307 to allow communication.

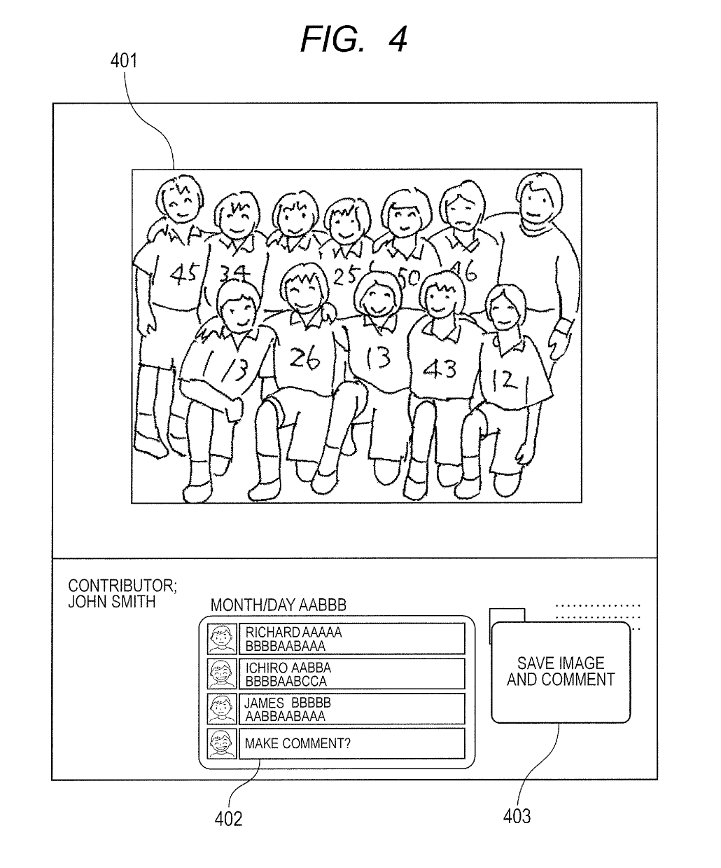

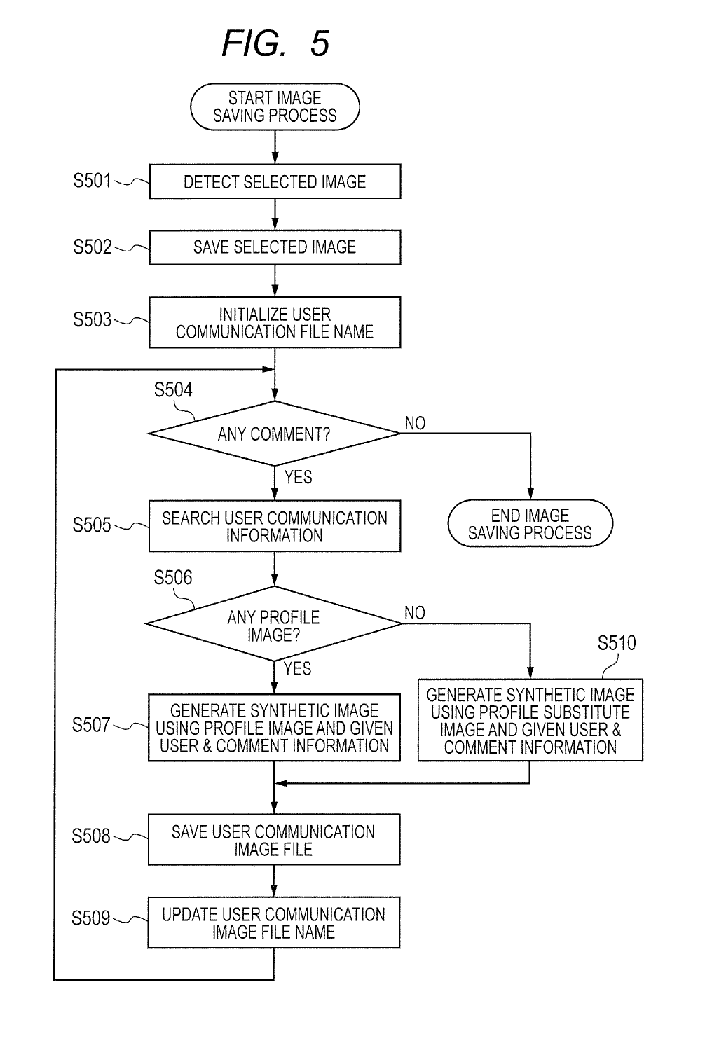

FIG. 4 schematically illustrates a configuration of a screen of the communication service displayed by the image browsing service on the user terminal 106 according to the present embodiment. For example, the screen is displayed when the user who uses the PC terminal 106 of FIG. 1 connects to the service through the network I/F 307. Specifically, the screen displays a service program operated on the RAM 303, an image file 401 that can be browsed by the user after user authentication for the service program, and user comments 402 of viewers of the image file. The image file 401 is information stored in the image DB 101. The user comments are information stored in the comment DB 102, and other than the comments, data, such as names of senders of comments and dates of comments, is included. The screen includes a “SAVE IMAGE AND COMMENT” button 403 that is a function unique to the image browsing service of the present embodiment, and when the user operates the button (service request), server operation of the present example of FIG. 5 is executed.

Operation of the server 104 according to the present example will be described in detail with reference to a flow chart of FIG. 5. These processing steps are executed by a program loaded from the ROM 302 to the RAM 303 as part of the communication service, when the program is activated by the operation of the button 402 by the user.

In S501, a selected image displayed as the image file 401 is detected. More specifically, a file name of the image file 401 is acquired to transfer the image file from the image DB on the external storage device 304 to the server 104. In S502, the acquired image file is saved in a given location of the PC terminal 106 through the network I/F 307 (image file acquisition). An initial value of the given location is set by the OS unless specifically designated, and the given location is a “Picture” folder of the individual user in the case of a PC.

In S503, a user communication file name is initialized. In the present example, a name obtained by adding “_{—}0001” to the file name saved in the PC terminal 106 in S502 is set as an initial value of the user communication image file name. File names are used by sequentially changing “_{—}0001” included in the initial value of the file name to “_{—}0002” and “_{—}0003” according to generation of new user communication image files. Therefore, the order of displaying the user communication image files can be controlled according to the file names. However, the file names for identifying the display order are not limited to this format.

Subsequently, in relation to the acquired image file, whether there is a comment of a viewer for the image file 401 is determined in S504. If there is a comment (if S504 is true), S505 is executed. Since there are three user comments 402 (fourth display illustrated in FIG. 4 is an input area) in the present example, S505 is executed.

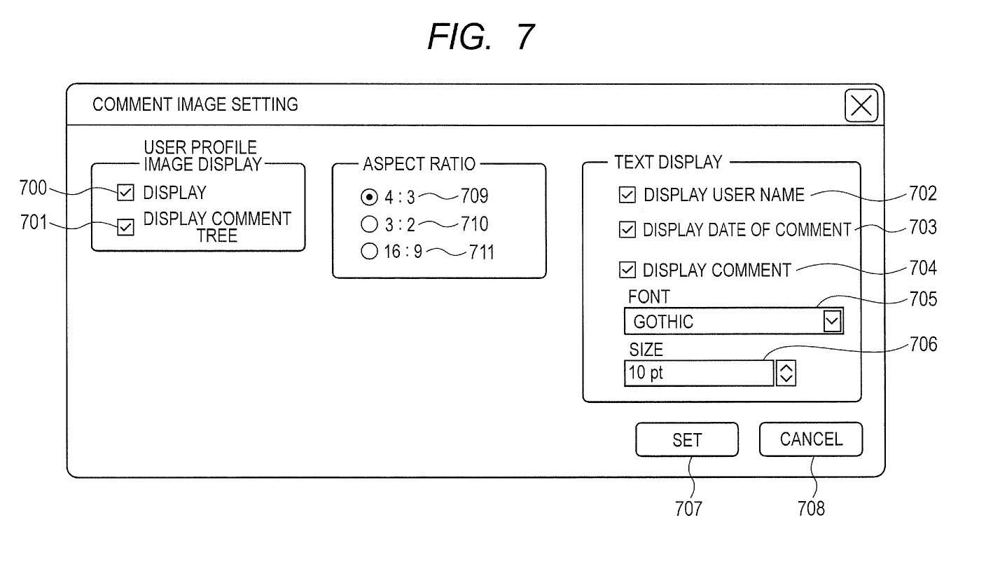

In S505, information is acquired from the user DB and the comment DB on the external storage device 304 according to user setting on a registration screen of FIG. 7 described later. Specifically, user information and comment information of the viewers who have commented are acquired according to the user setting (the information will be collectively called “user communication information”). In S506, whether a profile image is saved in the acquired communication information (user information) is determined. If the determination is true, the profile image and image information obtained by converting the acquired given user information (text information) and comment information (text information) are synthesized to generate a user communication image in S507. The generated user communication image is saved in a given location of the PC terminal 106 as a user communication image file in S508 (file generation), and the file name is updated in S509. The generated user communication image may not be data in a file format, but may be data recorded in association with the image file.

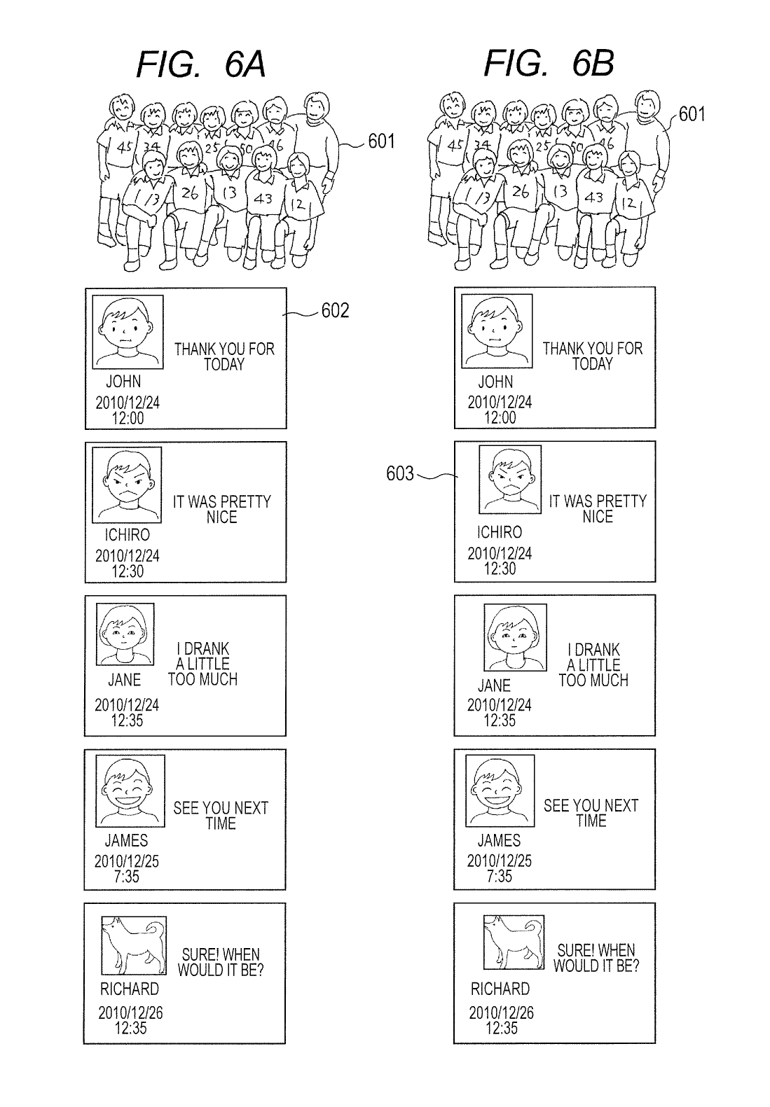

On the other hand, if the determination of S506 is false, a substitute image indicating the absence of the profile image and image information obtained by converting the given user information (text information) and comment information (text information) are synthesized to generate a user communication image in S510. The generated user communication image is saved in the PC terminal 106 as a user communication image file in S508. Since there are three user comments 402 in the present example (example of FIG. 2), the process passes through the loop of S504 to S509 two more times. Lastly, it is determined false in S504, and the processing flow ends. As a result, as illustrated in FIGS. 6A and 6B, an image file 601 (it is assumed that the file name is “file.jpg”) and three user communication image files 602 are saved in a given location of the PC terminal 106. The file names of the user communication image files are determined to be “file_{—}0001.jpg”, “file_{—}0002.jpg”, and “file_{—}0003.jpg” as described above.

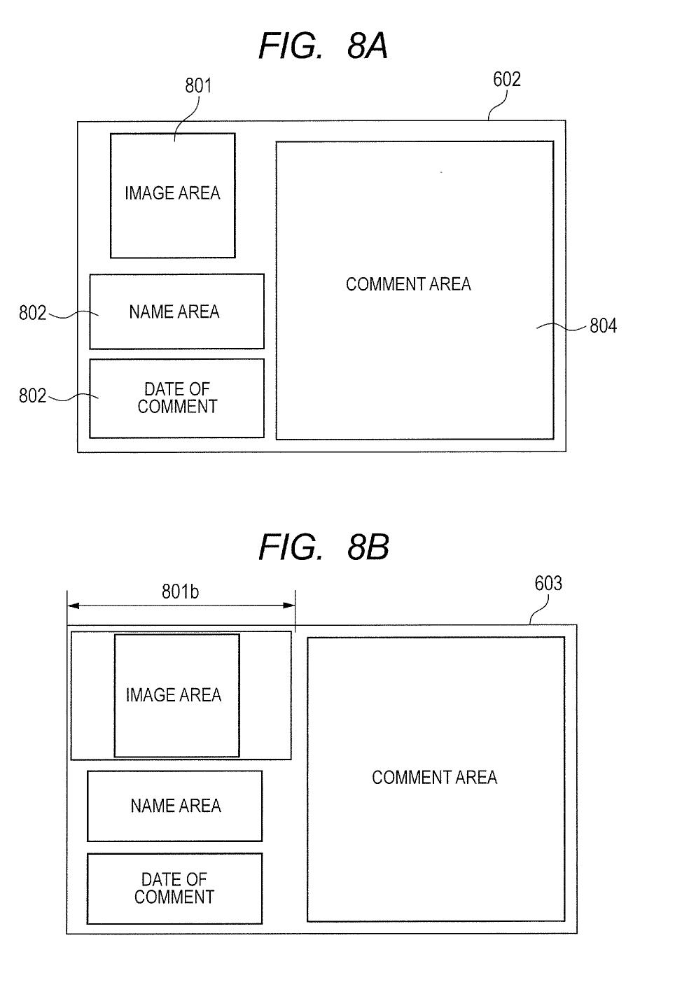

Detailed setting of the comment images, such as user text information and aspect ratio of image, used to generate the synthetic images in S507 and S510 is saved in advance in the user DB 103 upon user detail information registration in the user registration. FIG. 7 illustrates a registration screen in an embodiment of the present invention. In the present embodiment, the registration screen is used to set details of the user communication images in the present example and modified examples of the present example. The setting of FIG. 7 is reflected on a layout (synthetic position) of the user communication images illustrated in FIGS. 8A and 8B according to the content.

In FIG. 7, a check box 700 is for displaying the user profile image, and whether to put the user profile image of the user DB 103 in the user communication image is set. If the image is set, the user profile image is synthesized at a position of an image area 801 in the layout of the user communication image of FIG. 8A, in the setting illustrated in FIG. 7. Radio buttons 709 to 711 are for setting the aspect ratio of the user communication image, and the aspect ratio of one of the user communication images 602 and 603 illustrated in FIGS. 6A and 6B is set. Check boxes 702 and 703 are for switching and setting whether or not to display the user name of the user DB 103 and whether or not to acquire and display the date of the comment of the comment DB 102. Similarly, a check box 704 is for switching and setting whether or not to acquire and display the comment text. A font selection list box 705 and a spin box 706 of font size selection allow changing the font name and the font size. As a result of the setting, whether to display the text in the text area of the displayed image is set, and the text font and the text size in the display are set. If a setting button 707 is operated after the setting is selected, the setting is saved in the user DB 103. On the other hand, if a cancel button 708 is operated, the setting this time is not saved. Details of a check box 701 will be described in modified examples of the present example described later. In FIG. 7, “DISPLAY PROFILE IMAGE”, “DISPLAY COMMENT TREE”, “ASPECT RATIO 4:3”, “DISPLAY USER NAME”, “DISPLAY DATE OF COMMENT”, “DISPLAY COMMENT”, “USE GOTHIC FONT” and “FONT SIZE 10 pt” are set. The setting button 707 is operated to save the result of the setting in the user DB 103. The layout of the display of the user communication image corresponding to the setting registration is illustrated in FIG. 8A. The layout of the display of the user communication image when the check box 701 is checked is illustrated in FIG. 8B.

If the image file generated by the server 104 with the configuration described above is copied to a given location of the memory card in the PC terminal 106 and displayed by a digital camera, the images can be replayed and displayed in the order of FIGS. 6A and 6B. In the replay and display, the display can be freely advanced or turned back by operation members, such as buttons and wheels, of the digital camera. Therefore, even in the display after the termination of the connection with the network, the result of the communication service can be referenced while maintaining the searchability, without special software. Particularly, an advantageous effect of displaying One writers and the order of comments of the communication service in an easily understandable manner by simple operation using an advanced replay display function of image file of the digital camera can be attained in the digital camera.

### Modified Example 1

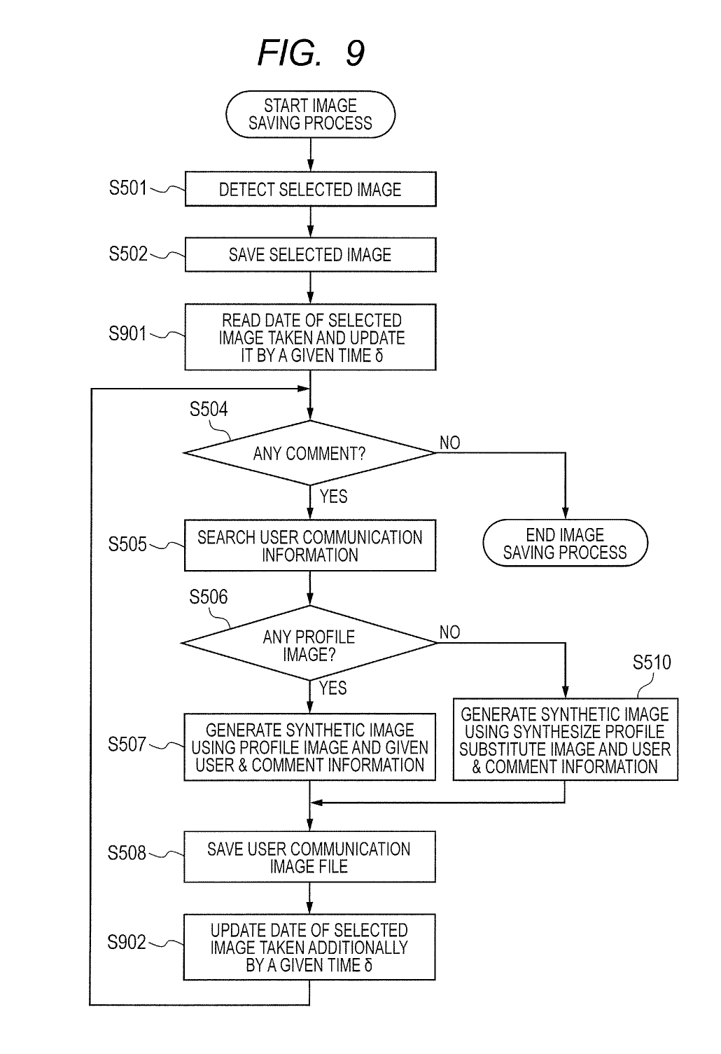

FIG. 9 is a diagram illustrating a flow chart of operation of an information imaging apparatus according to a first modified example of the first example of the present invention. In the operation of the present modified example, S503 is changed to S901, and S509 is changed to S902 in the flow chart of the operation of the information processing apparatus according to the first example illustrated in FIG. 5. In relation to this, the configurations related to the network and the display screen illustrated in FIGS. 1 to 3, 4, 6A, 7 and 8A are similar to those of the first example, and the description will not be repeated here unless particularly necessary. Hereinafter, operation different from the first example will be described.

Step S901 is a step of reading the date of imaging of the saved image file. In general, detailed information of an image taken by a digital camera is embedded in the image file as defined in EXIF 2.3 (CIPA DC-008-2010). For example, year, month, day, hour, minute and second are written in Date Time Original tag data, and the date of imaging is written in 1/100 seconds in Subset Time Original tag data. The data is acquired in S901 of the present modified example. A minute time δ (1/100 second in the present example) that is a given time for an increment is added to the data to calculate new date of imaging to be written in the user communication image file.

In S902, δ is further added to newly calculate the date of imaging to be written in the user communication image file.

In S508, to allow referencing the user communication image file just like the image file, the user communication image file is saved as an image file compliant with EXIF 2.3. As a result, the image file and the user communication image file can be sequentially referenced by a function of the digital camera for viewing images in the order of the date of imaging. Compared to the first example, the order of referencing the image file and the user communication image file does not depend on the file names in the present modified example. Therefore, even when a plurality of images in arbitrary file names taken by various cameras are obtained from an image reference service and saved, the images can be sequentially referenced. More specifically, all image files and user communication image files of the image files can be displayed in the order of the date of imaging to sequentially replay and display all files without losing the correspondence between the files.

### Modified Example 2

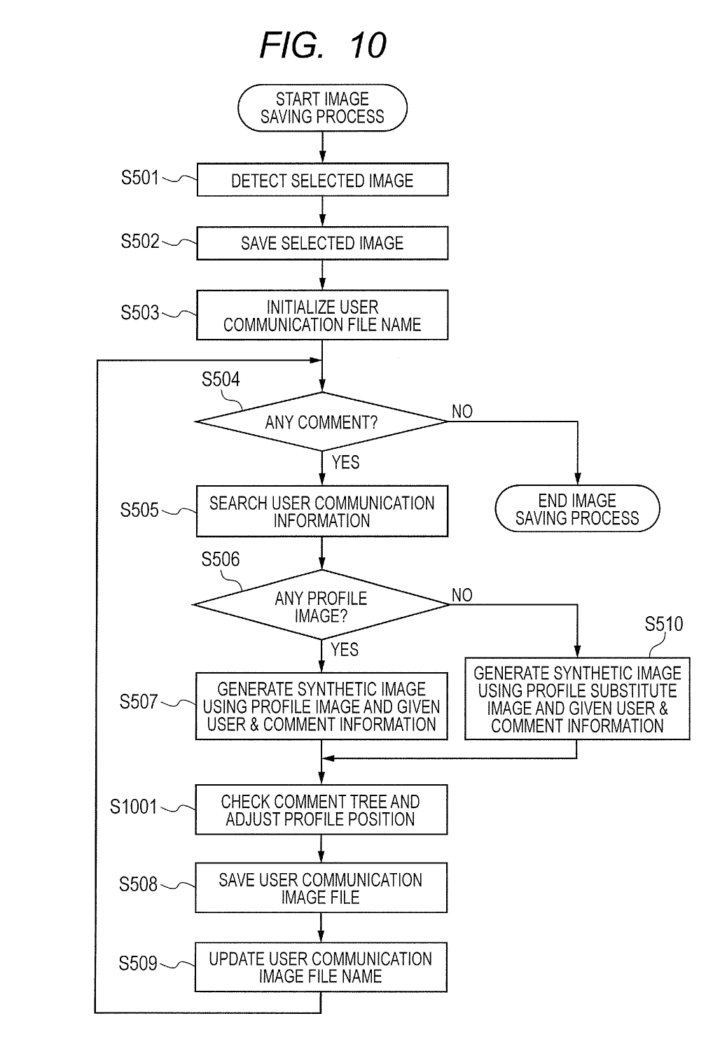

FIG. 10 is a diagram illustrating a flow chart of operation of an information imaging apparatus according to a second modified example of the first example of the present invention. In the operation of the modified example, S1001 is added to the flow chart of the operation of the information processing apparatus according to the first example illustrated in FIG. 5. In relation to this, the configurations related to the network and the display screen illustrated in FIGS. 1 to 3, 4 and 7 are similar to those of the first example, and the description will not be repeated unless particularly necessary. Hereinafter, operation different from the first example will be described.

Step S1001 is operation performed when the check box 701 of “DISPLAY COMMENT TREE” illustrated In FIG. 7 is set. When the cheek box 701 is set, whether the comment of the viewer is a response to a comment of another viewer (tree) is determined. This is a step of setting to move the position of the user profile image to the left or right within the range of an image area 801b in the layout of the user communication image of FIG. 8B according to the determination result.

As a result of the execution of this step, the display of the user communication image file is as illustrated in 603 of FIG. 6B. In FIG. 6B, it is determined that the comment of ICHIRO is a response to the comment of JOHN. Therefore, the profile image of ICHIRO is shifted to the right in the image relative to the profile image of JOHN, and the synthetic user communication image is saved. As a result, when the user communication image files are sequentially displayed, the trees of the comments can be understood by the positional relationship between the profile images. According to the present modified example, the communication of the image browsing service can be displayed in a more easily understandable manner.

### Modified Example 3

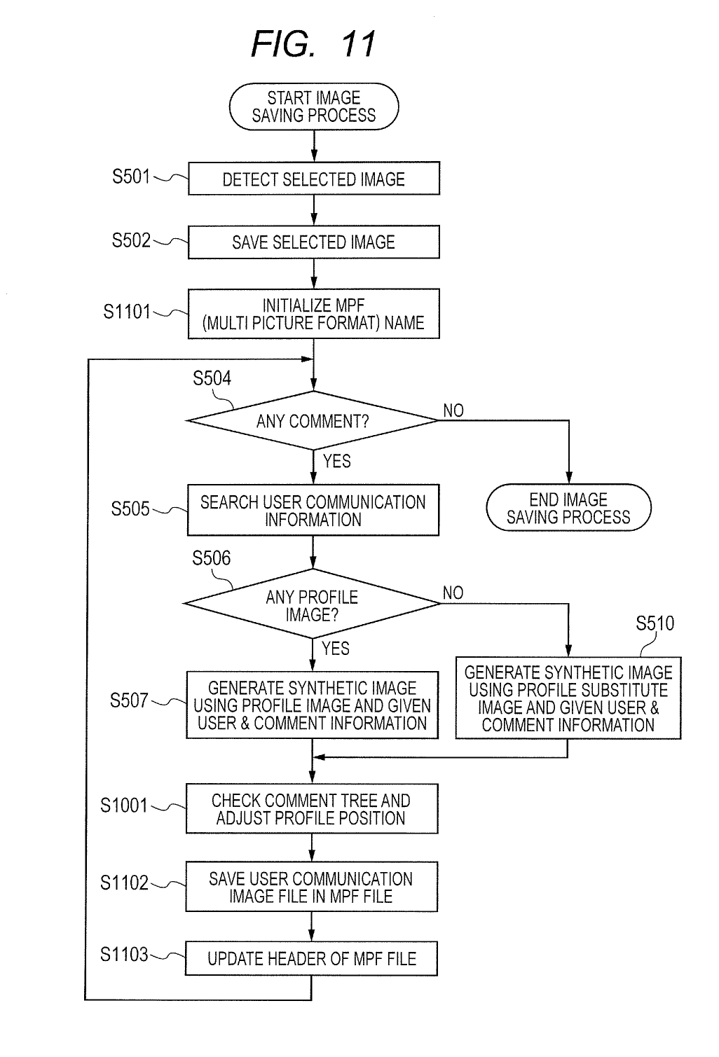

FIG. 11 is a diagram illustrating a flow chart of operation of an information processing apparatus according to a third modified example of the first example of the present invention. In the operation of the present modified example, S503 is changed to S1101, S508 is changed to S1102, and S509 is changed to S1103 in the flow chart of the operation of the information processing apparatus according to the second modified example of FIG. 10. In relation to this, the configurations related to the network and the display screen illustrated in FIGS. 1 to 3, 4, 6B, 7 and 8B are similar to those of the second modified example. Therefore, the description will not be repeated unless particularly necessary. Hereinafter, operation different from the second example will be described.

Step S1101 is a step of initializing the user communication file name and is a step of resetting an index count in an MPF (multi picture format) file to zero. In the present modified example, the file name of the MPF file is obtained by adding “_MPF” to the file name saved in the PC terminal 106 in S502.

In S1102, the file name saved in S1101 is used to save the user communication image file in the PC terminal 106. If this is the first saving (if the index count set in S1101 is zero), the current user communication image is newly saved as an initial image in the MPF format, and the index count in the MPF file is counted up in S1103. If the index count is not zero, in S1102, the current user communication image is added as a new image to an MPF file in which at least one user communication image is already saved in the processing flow. The MPF file as a user communication image file is overwritten and saved in the PC terminal 106.

According to these steps, the images of three comments from the comment of JOHN to the comment of RICHARD illustrated by 603 in FIG. 6B can be saved in one user communication image file of “file_MPF.jpg”. As a result, the image file and the user communication image file can be sequentially displayed by the MPF relay function of the digital camera, and the operation is possible with one file. Therefore, the file can be easily moved or deleted.

It is clear that the third modified example can be executed as a modified example of the operation of the information processing apparatus according to the first example illustrated in FIG. 5. In this case, the check box 701 of FIG. 7 is not checked, and the layout of the user communication image is as in FIG. 8A. Therefore, the user communication image file is replayed and displayed as in FIG. 6A.

Similarly, the first to third modified examples can also be appropriately combined to form a modified example of the first example.

Although the examples and the modified examples are described as processing operation of the image browsing server 104 illustrated in FIG. 1, it can be easily recognized that similar advantageous effects can be attained when the examples and the modified examples are carried out as processing operation of the client terminals 105, 106, 107 and 108. Although the user communication file includes one image for each comment in the examples and the modified examples, the comments can be included in one image to further improve the operability if the digital camera has high display performance.

A CPU or the like of the control unit 301 reads a program for realizing the functions of the processes illustrated in FIGS. 5, 9 and 11 from the ROM 302 to execute the program to realize the functions.

However, the present invention is not limited to the configuration, and all or part of the functions in the processes illustrated in FIGS. 5, 9 and 11 may be realized by dedicated hardware. The memory may be a computer-readable/writable recording medium. Examples of the recording medium include a non-volatile memory such as a magneto-optical disk apparatus and a flash memory, a read-only recording medium such as a CD-ROM, a volatile memory other than the RAM, and a recording medium formed by a combination of these.

The program for realizing the functions of the processes illustrated in FIGS. 5, 9 and 11 may be recorded in a computer-readable recording medium, and a computer system may read and execute the program recorded in the recording medium to execute the processes. The “computer system” here includes hardware such as the OS and peripheral devices. Specifically, the present invention includes a case in which a program read from a storage medium is written in a memory included in a function expansion board inserted to a computer or included in a function expansion unit connected to a computer. In this case, after the program is written, a CPU or the like included in the function expansion board or the function expansion unit executes part or all of the actual processes based on instructions of the program, and the processes realize the functions of the embodiments.

According to the embodiment described above, even in the display after the termination of the connection with the network, the result of the communication service can be referenced while maintaining the searchability, without special software. Particularly, an advantageous effect of displaying the writers and the order of comments of the communication service in an easily understandable manner by simple operation using an advanced replay display function of image file of the digital camera can be attained in the digital camera.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-186698, filed Aug. 27, 2012, which is hereby incorporated by reference herein in its entirety.

What is claimed is:

1. An information processing apparatus that acquires an image provided from an image browsing service on the Internet and acquires user communication information related to the image, the information processing apparatus comprising:
an image acquisition unit configured to acquire the image from the image browsing service;
an information acquisition unit configured to acquire, from the image browsing service, user communication information including user information registered in the image browsing service and including at least one piece of text information for the image; and
a generation unit configured to convert the at least one piece of text information acquired by the information acquisition unit to image information and to synthesize the user information and the converted image information to generate a user communication image.

2. The information processing apparatus according to claim 1, further comprising
a recording unit configured to record the image acquired by the image acquisition unit and the user communication image generated by the generation unit as separate images in one file in a memory.

3. The information processing apparatus according to claim 2, wherein
the recording unit records the file in a Multi Picture Format.

4. The information processing apparatus according to claim 1, wherein
the generation unit synthesizes the information by changing a configuration position of the acquired text information based on a tree of the text information.

5. The information processing apparatus according to claim 1, further comprising
a transmission unit configured to transmit the file recorded in the memory to a camera.

6. The information processing apparatus according to claim 1, wherein
the at least one piece of text information included in the user communication information is one of a user name, a date of comment and a user comment, and the user information includes a profile image of a user.

7. An information processing method for acquiring an image provided from an image browsing service on the Internet and for acquiring user communication information related to the image, the method comprising:
acquiring the image from the image browsing service;
acquiring, from the image browsing service, user communication information including user information registered in the image browsing service and including at least one piece of text information for the image;
converting the at least one piece of text information to image information; and
synthesizing the user information and the converted image information to generate a user communication image.

8. The information processing method according to claim 7, further comprising
recording the image and the user communication image as separate images in one file in a memory.

9. The information processing method according to claim 8, wherein
the recording records the file in a Multi Picture Format.

10. The information processing method according to claim 7, wherein
the synthesizing synthesizes the information by changing a configuration position of the acquired text information based on a tree of the text information.

11. The information processing method according to claim 7, further comprising
transmitting the file recorded in the memory to a camera.

12. The information processing method according to claim 7, wherein
the at least one piece of text information included in the user communication information is one of a user name, a date of comment and a user comment, and the user information includes a profile image of a user.

13. A non-transitory computer-readable recording medium having recorded therein a program for causing a computer to execute a information processing method for acquiring an image provided from an image browsing service on the Internet and for acquiring user communication information related to the image:
acquiring the image from the image browsing service;
acquiring, from the image browsing service, user communication information including user information registered in the image browsing service and including at least one piece of text information for the image;
converting the at least one piece of text information to image information; and
synthesizing the user information and the converted image information to generate a user communication image.
